(19) United States
(12) Patent Application Publication
(10) Pub. No.: US 2020/0267165 A1
(43) Pub. Date: Aug. 20, 2020

(54) METHOD AND APPARATUS FOR DETECTION AND CLASSIFICATION OF UNDESIRED ONLINE ACTIVITY AND INTERVENTION IN RESPONSE

(71) Applicant: Fido Voice Sp. z o.o., Sopot (PL)

(72) Inventors: Gniewosz Leliwa, Gdansk (PL); Michal Wroczynski, Sopot (PL); Grzegorz Rutkiewicz, Gdansk (PL); Patrycja Tempska, Gdynia (PL); Maria Dowgiallo, Sopot (PL)

(73) Assignee: Fido Voice Sp. z o.o., Sopot (PL)

(21) Appl. No.: 16/792,394

(22) Filed: Feb. 17, 2020

Related U.S. Application Data
(60) Provisional application No. 62/807,212, filed on Feb. 18, 2019.

(51) Int. Cl. H04L 29/06; G06F 16/958; G06F 16/955; G06F 16/9536; G06N 5/02; G06N 5/04; H04L 12/58

(52) U.S. Cl. CPC H04L 63/1408; G06F 16/958; G06F 16/955; G06N 20/00; G06N 5/02; G06N 5/04; H04L 51/02; G06F 16/9536

(57) ABSTRACT

An intervention method and system for intervening in online bullying is described. in various embodiments, and an online violence detection system available online on communicatively coupled to multiple databases and the multiple system processors, wherein the online detection system is also communicatively coupled to multiple online communities, multiple data sources, and multiple other online systems and online applications. The method and system determine whether autonomous instant action is appropriate, or whether referring the interaction to a moderation dashboard is appropriate. A moderator dashboard is included in one embodiment.

### RELATED APPLICATION

The present application relates to and claims the benefit of priority to U.S. Provisional Patent Application Ser. No. 62/807,212 filed 18 Feb. 2019, which is incorporated herein by reference in its entirety for all purposes as if fully set forth herein.

### BACKGROUND OF THE INVENTION

The development of the Internet—among many undeniable benefits—is contributing to the proliferation of new threats for its users, especially kids and online communities. Such communities can express themselves, hang out and have conversations using online services such as messengers, chatrooms, forums, discussion websites, photo and video sharing services, social networking services, and so on. The threats come from other Internet users who act against healthy conversations for a variety of reasons. Online violence (or cyberviolence) is one of the most common undesirable behaviors within online communities, whereas the most common method for combating it is content moderation. Furthermore, online violence is one of the primary reasons why users leave online communities and it contributes (especially cyberbullying) to much more dangerous effects, including suicides among children and youth.

Online violence can be broadly defined as any form of abusing, harassing, bullying or exploiting other people, using electronic means. Some communication phenomena such as hate speech, toxic speech or abusive language overlap with online violence to some extent, whereas the other phenomena like cyberbullying or sexual harassment are entirely included into online violence. Online violence puts emphasis on harming other people. For example, using the word “f*cking” as an intensifier to stress out the positive emotions towards other person, e.g. “you are f*cking awesome”, is not online violence.

Currently, the most common approach to moderate content and reduce online violence within a given community is to hire a team of human moderators and ask them to verify other users contributions and to take proper actions whenever a community guideline is violated. FIG. 2 is a block diagram of a prior art content moderation workflow 200. First, the text is written by a user and Published 210. Depending on the type of online community (e.g. a chatroom or an online forum), the text can be published as a post, comment, public message, private message, and so on. It is also possible for an online community to introduce a simple keyword-based filtering that can stop the text from publication. However, such filtering is very easy to bypass and therefore should is nor effective as the only solution for content moderation.

After Publishing 210, the text can be presented in Moderation Dashboard 240, where it is verified by moderators who can take Moderator's Action 250 if the text violates community guidelines. In most cases, moderators use only negative motivation system—punishments for violating community guidelines such as warnings, deleting messages, privilege suspensions and bans. Furthermore, moderators have their hands tied when it comes to online violence that does not violate community guidelines.

Typically, the volume of texts in online communities is too big to be handled even by a large team of moderators. This is the reason why moderators use additional methods to select and prioritize texts with higher chance of violating community guidelines. There are two major methods widely used in content moderation that can be used either separately or jointly in any working configuration:

1. User Reporting 220 allows users to report certain texts as containing online violence. Moderators see which texts were reported in Moderation Dashboard 240. In many communities, a single text can be reported independently by different users. Usually, each report further confirms the violation of community guidelines and increases the urgency for taking Moderator's Action 250. Some moderation tools allow to set thresholds on the count of user reports in order to alert moderators (e.g. text message after third user report) or even take some automatic actions (e.g. deleting the text after fifth user report).

2. Toxicity Detection System 230 is typically a natural language processing system designed to determine whether or not an input text contains toxic speech, where toxic speech can be defined as a rude, disrespectful, or unreasonable comment that is likely to make other users leave a discussion. Some systems allow to classify an input text into more than one category of toxic speech. According to that definition, toxic speech comprises a very broad spectrum of online behaviors and using toxic speech is not necessarily equal to violating community guidelines. Furthermore, such systems usually provide low precision as they tend to over-focus on certain keywords and expressions that often co-occur with toxic speech (such as vulgarisms).

It would be desirable to have a content moderation system introducing social interventions and positive motivation system that relies on convincing violent users to refrain from their violent behaviors rather than just punishing them. It would be desirable to have a content moderation system that not only allows to reduce online violence but also minimizes the number of banned users as many of them can be convinced. It would be desirable to have a system that does not need to replace the prior art workflow but rather can complement it with new effective methods. It would be desirable to have a system that can be used with any existing moderation dashboard after a simple integration, with newly created dashboard and even without any dashboard at all. It would be desirable to have a system that can be completely autonomous by using chatter bots or semi-supervised by human mediators. It would be desirable to have a system that allows to use various intervention strategies, create new ones and select the most effective ones with dedicated methodology and many optimization techniques.

### BRIEF DESCRIPTION OF THE DRAWINGS

FIG. 1 is a block diagram of an intervention system environment according to an embodiment.

FIG. 2 is a block diagram of a prior art content moderation workflow.

FIG. 3 is a block diagram of a content moderation workflow enhanced with an intervention system according to an embodiment.

FIG. 4 is a diagram illustrating the process of performing a single intervention according to an embodiment.

FIG. 5 is a block diagram of general architecture of intervention system modules according to an embodiment.

FIG. 6 is a block diagram of message analyzer module according to an embodiment.

FIG. 7 is a flow diagram illustrating an instance of community intelligence module according to an embodiment.

FIG. 8 is a block diagram illustrating an instance of text generation module according to an embodiment.

FIG. 9 is a block diagram of an intervention system utilizing a moderation dashboard according to an embodiment.

FIG. 10 is a diagram illustrating a process of performing a group intervention according to an embodiment.

FIG. 11 is a diagram illustrating a process of sending non-intervention message according to an embodiment.

### DETAILED DESCRIPTION

The present invention relates to computer-implemented methods and systems for improving content moderation by introducing social interventions in order to reduce undesirable behaviors within online communities. More particularly, the invention relates to reducing online violence by attempting to convince violent users to refrain from such behaviors. The social interventions are performed by either chatter bots (automatic agents) or human mediators (professional or amateur) using non-punishing methods—sending specially prepared messages instead of blocking/deleting messages or banning users.

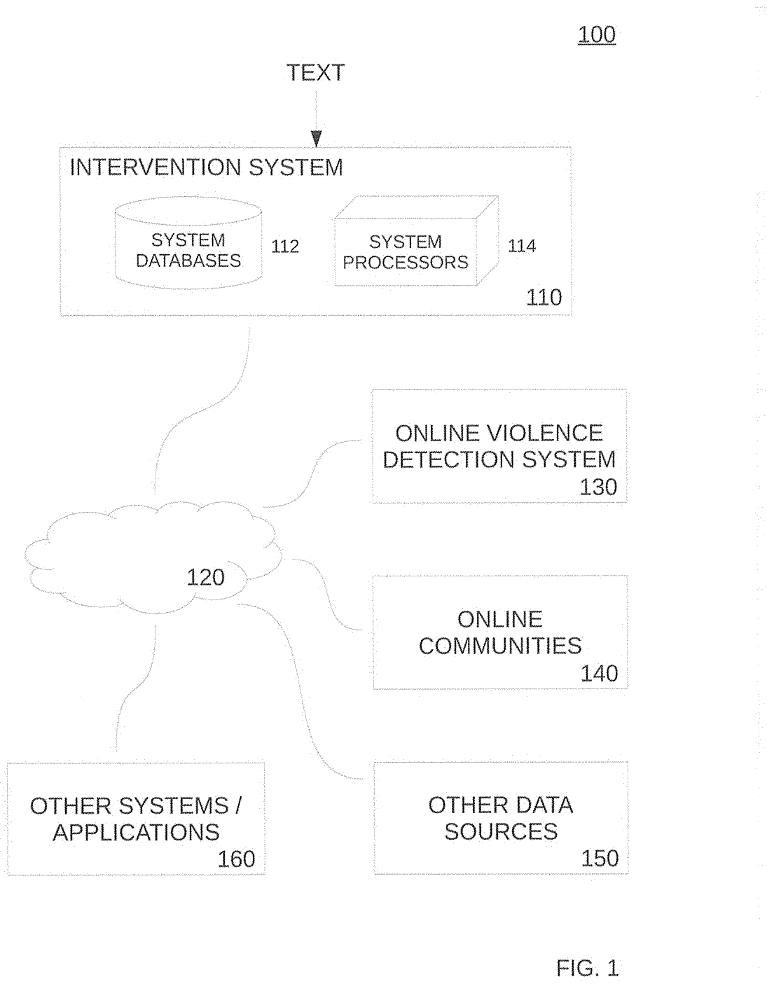

FIG. 1 is a block diagram of an intervention system environment 100 according to an embodiment. Intervention System 110 accepts text or any dataset containing text as input. Text primarily consists of user-generated content written by users of Online Communities 140. It can include electronic data from many sources, such as the Internet, physical media (e.g. hard disc), a network connected database, etc. Alternatively, text can come from Other Data Sources 150 that include any source of electronic data that could serve as a source of text input to Intervention System 110. Big data collectors, integrators and providers working with online services related to online communities are examples of Other Data Sources 150.

Intervention System 110 includes multiple System Databases 112 and multiple System Processors 114 that can be located anywhere that is accessible to a connected network 120, which is typically the Internet. System Databases 112 and System Processors 114 can also be distributed geographically in the known manner. Intervention System 110 uses Online Violence Detection System 130 in order to verify whether or not input text contains online violence and to determine online violence categories. Online Violence Detection System 130 can be either installed on the same device as Intervention System 110 or located anywhere that is accessible to a connected network 120 (typically the Internet) and distributed geographically in the known manner. In an embodiment, Online Violence Detection System 130 is deployed using any cloud computing service and available through an application programming interface (API).

In general, Intervention System 110 takes in the input data from Online Communities 140 and provides interventions back to Online Communities 140, either with or without the usage of additional moderation tools and dashboards. In an embodiment, user accounts for chatter bots that read texts and provide interventions are created within Online Communities 140 and are fully controlled by Intervention System 110 through an API provided by Online Communities 140. Other embodiments can comprise any other forms of integration and communication between Intervention System 110 and Online Communities 140, including full on-premise integrations. Depending on the needs and integration capabilities, user accounts for both chatter bots and human mediators can be created and prepared beforehand (e.g. account history to make it more credible) or dynamically according to the on-going demands for certain personalities.

Other Systems/Applications 160 are systems, including commercial and non-commercial systems, and associated software applications that cannot be perceived as Online Communities 140 but still have the capability to access and use Intervention System 110 through one or more application programming interfaces (APIs) as further described below. For the sake of clarity, online community can be defined as any group of people who discuss anything using the Internet as a medium of communication. Therefore, even people who know each other in real life (e.g. friends from college or co-workers) can be treated as an online community while using any instant messaging platform or service.

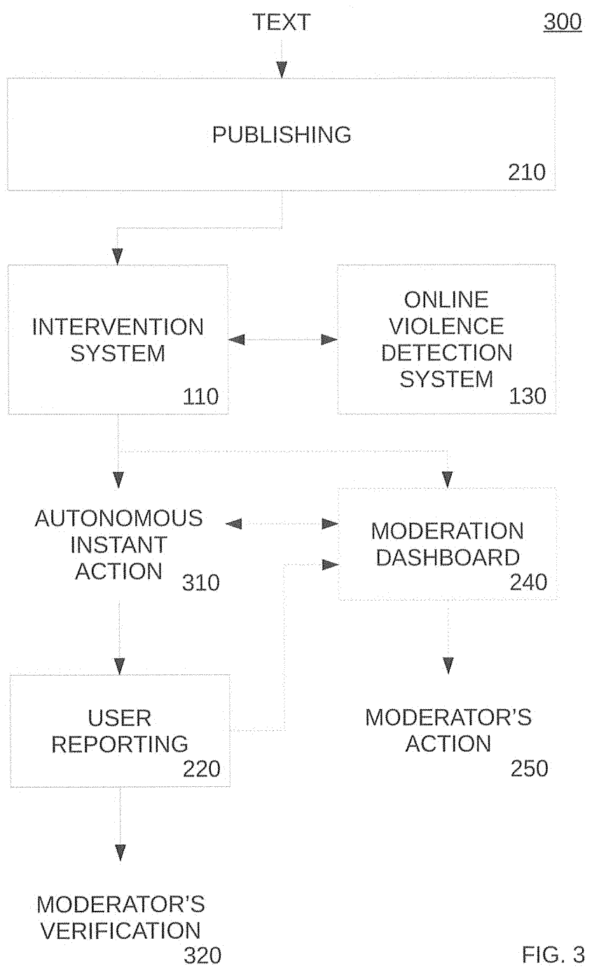

FIG. 3 is a block diagram of a content moderation workflow enhanced with an intervention system according to an embodiment. Two options are presents. In the first option, with solid blocks and lines, assumes that moderators perform only a controlling function over Intervention System 110. Intervention System 110 processes published texts using Online Violence Detection System 130 and performs Autonomous Instant Action 310. Autonomous Instant Action 310 represents a variety of actions that Intervention System 110 can take, ranging from performing interventions and ending with the whole spectrum of typical moderator's actions, including deleting messages and banning users. However, in order to be able to take these moderator's actions, the user accounts usually have to be provided with proper authorizations.

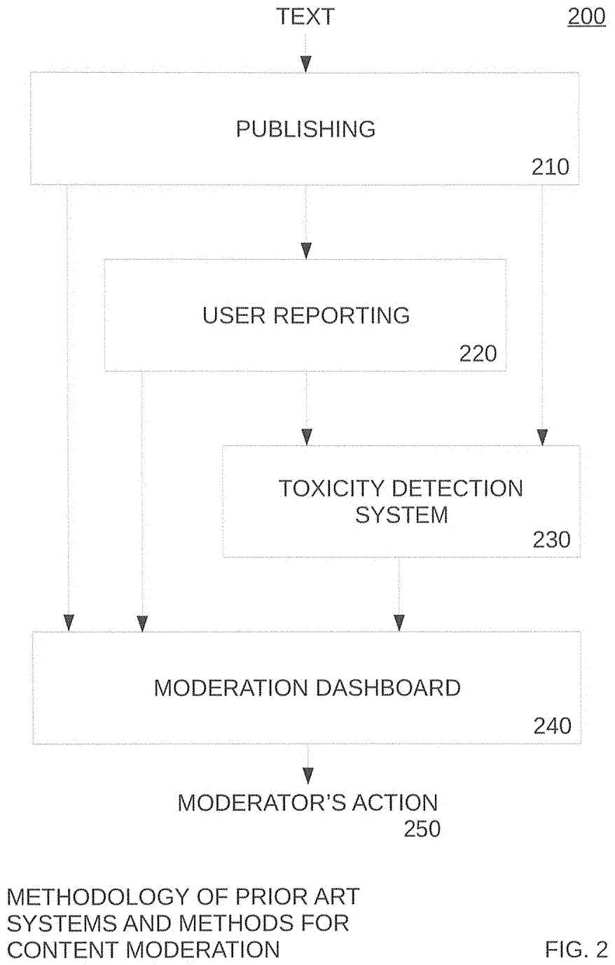

Autonomous Instant Action 310 can be therefore monitored by moderators. Wrong decisions of Intervention System 110 can be corrected with Moderator's Verification 320. A dispensable or inappropriate intervention can be deleted or replied to with a proper explanatory message, whereas other actions can be reversed as soon as they are spotted. It is very reasonable to allow users to report invalid actions performed by Intervention System 110 exactly as they can be allowed to report texts violating community guidelines as presented in FIG. 2. User Reporting 220 with thresholds can be used to set alerts informing about the necessity of Moderator's Verification 320 (e.g. via email or text message).

The second option of is represented with dotted blocks and lines. It still allows Intervention System 110 to perform Autonomous Instant Action 310, but also sets Moderation Dashboard 240 in the center of the content moderation process. In this case, any output of Intervention System 110 can go through Moderation Dashboard 240 and therefore moderators can examine any Autonomous Instant Action 310. Alternatively, the system autonomy can be turned off and—as a result—any action would have to be confirmed or rejected by moderators. It is also possible to connect these two approaches making some actions autonomous and requiring supervision for the others. For example, interventions can be still performed autonomously, whereas deleting messages and blocking users would require moderator's confirmation. Information from User Reporting 220 can also go through Moderation Dashboard 240 in order to help moderators take Moderator's Action 250. In this option, Moderator's Verification 320 can be seen as a part of Moderator's Action 250 since all important information goes through Moderation Dashboard 240.

Interventions

Intervention is a message (or messages) that is sent to a user who violated community guidelines with his/her message. The primary objective of intervention is to convince the violent user to stop violating community guidelines in the future. It is not uncommon for the user to delete or edit the message after intervention in order to remove the cause of violation. This kind of activity can be treated as a positive side effect. The form of message depends on the type of communication used on the service that the community is operating on. There are two major types of communication:

1. Chat offers a real-time transmission of text messages from sender to receiver (or receivers in one-to-many group chats). This type is typical for a range of chat services, including messaging apps and platforms as well as dedicated chats on websites and services, including chats on streaming and content sharing platforms and various customer support/help desk services. For this type of communication, the primary form of message is a text message sent within the same chatroom (or other organizational unit) where the violent user message was sent. The secondary form is a private or direct message sent directly to the violent user (not visible by other users).

2. Forum offers a conversation in the form of posted messages. The main difference between forum and chat is that forum messages at least temporarily archived and available for the users. Also, forum messages are often longer than chat messages. Forums can be organized in more complex hierarchical manner, e.g posts (original and following), comments-to-posts and comments-to-comments. For content sharing platforms, a video or an image with description can be treated as a post. This type is represented by online forums, message boards, image boards, discussion websites, social networking services and content sharing apps and platforms. For this type of communication, the primary form of message is a post or comment sent as a reply to the post or comment sent by the violent user. The secondary form is similar to the chat form—a private or direct message sent to the violent user and not visible by other users.

Interventors

Intervention is sent using a user account from an online community (service). The user account can be controlled by either human or machine. The machine-controlled account is called a chatter bot and should be treated as a default and fundamental setting for the invention. The human-controlled account is therefore an available additional setting. An entity performing intervention will be called an interventor. Many different interventors can be used simultaneously within the same community. For example, it can be very effective to let the chatter bots handle 90% of the common violations and ask the human mediators to solve the remaining 10% of the most sensitive cases. There are four types of interventors that can be described using pros and cons matrix:

1. Concealed chatter bot (CCB) is a machine-controlled account (automatic agent) that pretends to be a real user. It uses responses generated by Intervention System 110 based on type and severity of detected online violence and knowledge about particular violent user and online community.

Pros:
immediate response (real-time, but can be delayed in order to look more natural),
full control over chatter bot's behavior and identity (profile setting and history),
possibility to perform group interventions.

Cons:
no knowledge or understanding of the social context,
risk of being exposed.

2. Revealed chatter bot (RCB) is a machine-controlled account (automatic agent) that can be clearly recognized as a non-human bot by other users (does not try to hide this information). RCB can be authorized by a human moderator as an official auto moderator and gain additional credibility. It uses responses generated by Intervention System 110 based on type and severity of detected online violence and knowledge about particular violent user and online community.

Pros:
immediate response (real-time, no need for delays),
no risk of being exposed=no need for an elaborate and sophisticated set of messages,
higher authority, especially with moderator's credentials (everyone knows it is a bot).

Cons:
users may get a sense of being censored which may cause an opposite effect (reactance),
lower influence of some types of interventions (e.g. empathetic),
no possibility to perform some types of interventions (e.g. group).

3. Amateur human mediator (AHM) is a human agent with no skills in mediation or experience in solving conflicts between people. It can be a regular user of the service or an employee/volunteer who is informed about a guideline violation and asked to intervene as soon as possible: a) using a fixed list of proposed responses delivered by Intervention System 110, b) using a dedicated guide, c) using own intuition. AHM can be additionally provided with the same information as chatter bots (type and severity of detected online violence and knowledge about particular violent user and online community).

Pros:
good understanding of the social context,
more natural choice of responses (even if AHM uses the same repertory of answers),
potentially lower cost of hiring in comparison to professional mediators,
can be hired from trusted members of the community (ability to recognize local slurs, better understanding of specific context and slang).

Cons:
slower response (in comparison to chatter bots),
lower control over agent's behavior and identity (profile setting and history),
exposition to negative, aggressive and abusive content causes stress and in the long term leads to a burn out or even PTSD.

4. Professional human mediator (PHM) is a human agent skilled in mediation and having experience in solving conflicts between people. It can be an employee of the service (or a volunteer) who is informed about a guideline violation, provided with the same information as chatter bots (type and severity of detected online violence and knowledge about particular violent user and online community) and asked to intervene as soon as possible using his/her knowledge and experience.

Pros:
potentially the most effective and adaptable interventors,
very good understanding of the social context,
more natural choice of responses based on many years of experience,

Cons:
slower response (in comparison to chatter bots),
high cost of hiring professional mediators (unless they are volunteers).

The efficiency of the concealed chatter bots (CCBs) can be increased by developing their identity (proper username, profile setting and history). Although this approach is the most effective for the CCBs, it can be applied to other interventors to some degree. There are two major categories of the bot's identity that can affect the effectiveness of its interventions:

1. Being a part of the same group as the violent user, including (but not limited to): gender, age, nationality, race, religion, team, avatar. These aspects (if applicable within a service) can be defined during account creation or profile edition. Even for services that allow to set only a username, it is possible to set the identity by using the username to imply gender, nationality, age and even nationality or race. For example, username “john 1988” implies that the user is a 32 years-old (in 2020) male, probably from English-speaking countries.

2. Having high social index, including (but not limited to): number of followers, in-game status, community points (karma, likes, stars). The social index can be increased in two ways:
organic (time-consuming): by generating regular user activities such as writing messages, posts and comments, inviting friends and followers, earning in-game/community points,
artificial (instant, but requires close collaboration with the service): by changing account parameters related to the social index.

Intervention System 110 is capable of dynamic management of chatter bots, including adding new bots to the system, assigning them to certain groups of violent users, and even generating new chatter bots on the fly in case of close collaboration with the service. This topic will be described in details later in this document.

Types of Interventions

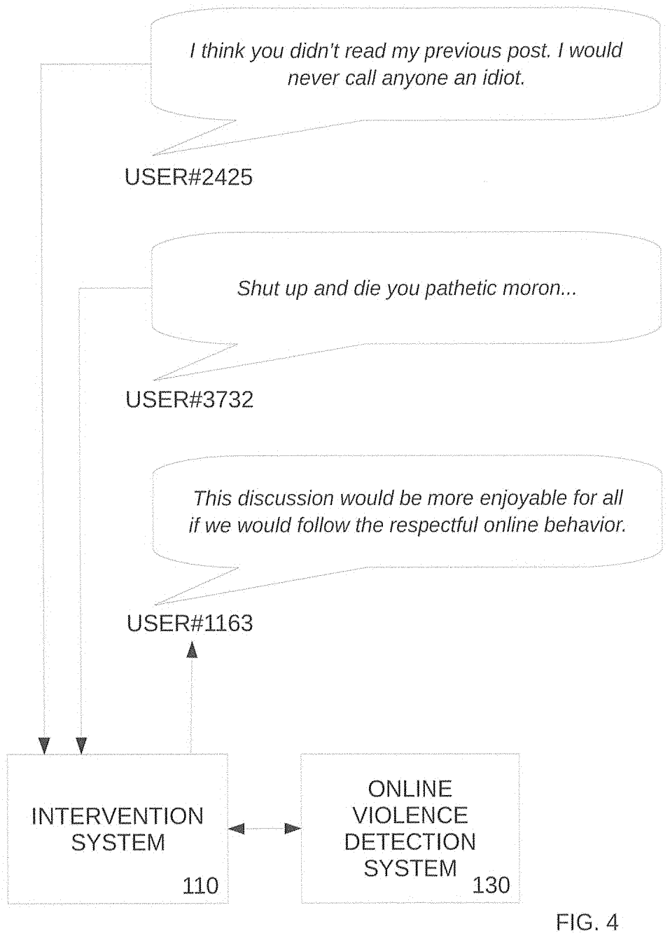

FIG. 4 is a diagram illustrating the process of performing a single intervention according to an embodiment. The diagram shows an exemplary exchange of messages between three users that can be identified with their IDs: USER#2425, USER#3732, USER#1163. This could be a regular conversation using either a chat or a forum. The messages appear chronologically from the top to the bottom. The first message written by USER#2425 is sent to Intervention System 110 and then to Online Violence Detection System 130, where it is classified as not containing online violence. There is no system reaction at this point. The second message from USER#3732 is also sent to Intervention System 110 and Online Violence Detection System 130, where it is classified as online violence. USER#1163 is a concealed chatter bot controlled by Intervention System 110. The violent message detection triggers an autonomous reaction: USER#1163 replies to the violent comment with an intervention from one of predefined intervention groups. In this case, the system sends a utilitarian message that refers to a utilitarian perspective showing how the discussion could be more fruitful and pleasurable for all under specific conditions.

Types of interventions can be defined using any applicable criteria. One method of defining types of interventions is to use knowledge from social science researches. Therefore, one could define types of interventions by the category they refer to:
empathetic, referring to user's empathy, e.g. “Please, remember that there is another human being on the other side.”;
normative, referring to social or community's norms, e.g. “Please, stop. You are violating out community guidelines.”;
authoritative, referring to well-known authorities, e.g. “Every time I feel this way I remind myself of Benjamin Franklin's quote: instead of cursing the darkness, light a candle.”.

Another strategy is to define types of interventions by the effect one wants to induce on violent users, e.g. trying to influence a more thoughtful attitude in the discussion by referring to empathy as strength or trying to give the attacker a broader perspective by referring to the common humanity. Utilitarian messages comprise another example of effect-driven types of intervention. In an embodiment, types of interventions can be defined with an arbitrary hierarchical structure. The main categories can be composed from subcategories, and so on. Furthermore, the categories and subcategories can overlap with each other. For example, some of the effect-driven types can have a common part of interventions with the empathetic type.

Revealed chatter bots due to their transparency can utilize another strategy—creating personality-driven interventions. It is possible to create artificial personalities using stereotypes or already existing archetypes from books and movies. For example, one can create a chatter bot acting like a stereotypical and exaggerated grandmother that non-stop refers to “good old times” in her interventions and treats every user like her grandchild. In this case, one has to prepare the interventions that support the role play of the chatter bot.

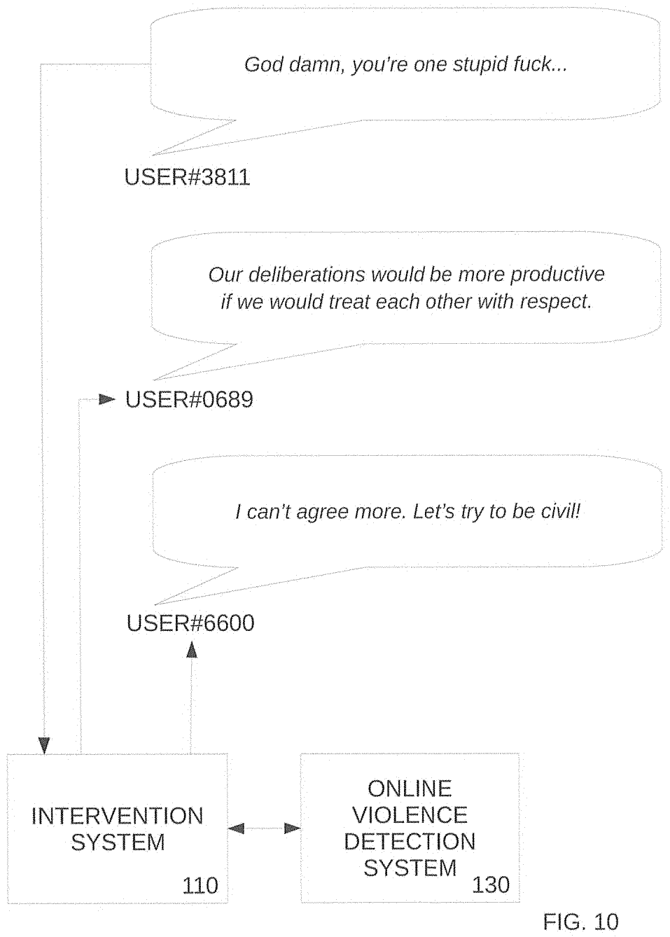

FIG. 10 is a diagram illustrating the process of performing a group intervention according to an embodiment. This is a special type of intervention that can be applied to any other type of intervention. It amplifies a single intervention by involving other interventors as supporters. The diagram shows another exemplary exchange of messages between three users that can be identified with their IDs: USER#3811, USER#0689, USER#6600. The first message written by USER# 3811 is sent to Intervention System 110 and Online Violence Detection System 130 classifies it as online violence. USER#0689 and USER#6600 are both concealed chatter bots controlled by Intervention System 110. USER#0689 replies with another utilitarian intervention and USER#6600 supports this reply with another message. Group interventions can be very effective in certain situations due to the usage of peer pressure. In an embodiment, group interventions can be defined as a separate category comprising second, third (and subsequent) replies. These replies can be individually assigned to all other types of interventions or just to the selected types that they can work with. In other embodiment, group interventions comprise a regular type (like any other type) of intervention and are defined starting with the first reply.

Aside from the interventions, concealed chatter bots can apply non-interventional activity to increase their credibility as regular members of online community. Every concealed chatter bot can be scripted in regard to how it should react to the selected types of non-interventional activities. In order to do so, a chatter bot can be equipped with additional NLP modules that can be developed within Intervention System 110 or can be provided by external services and platforms, including (but not limited to):
predefined knowledge bases to hold a conversation about specific topic (e.g. weather, politics, cooking, “small talk”);
various (both symbolic and statistical) NLP tools for classifying ongoing conversations and single utterances in regard to their topics and function (e.g. recognizing questions);
various (both symbolic and statistical) NLP methods for connecting classified information from conversations and utterances with information from knowledge bases in order to provide reasonable utterances for ongoing discussions;
learning modules for enriching the aforementioned elements based on other users' behaviors and reactions.

In an embodiment, Intervention System 110 is equipped with a knowledge base that covers popular conversation topics, a set of predefined scripts and classifiers designed to work with the internal knowledge base and a dedicated scripting language that allows to integrate external classifiers and knowledge bases. The predefined scripts allow to set high-level behavioral patterns describing how a chatter bot reacts under given conditions, including (but not limited to):
following other users' reactions, e.g. congratulating when other users congratulate;
avoiding private or direct messages, e.g. ignoring them or answering with predefined excuses;
being proactive in specific situations, e.g. telling jokes, funny facts or pasting links to pictures and videos after a longer period of silence on the channel.

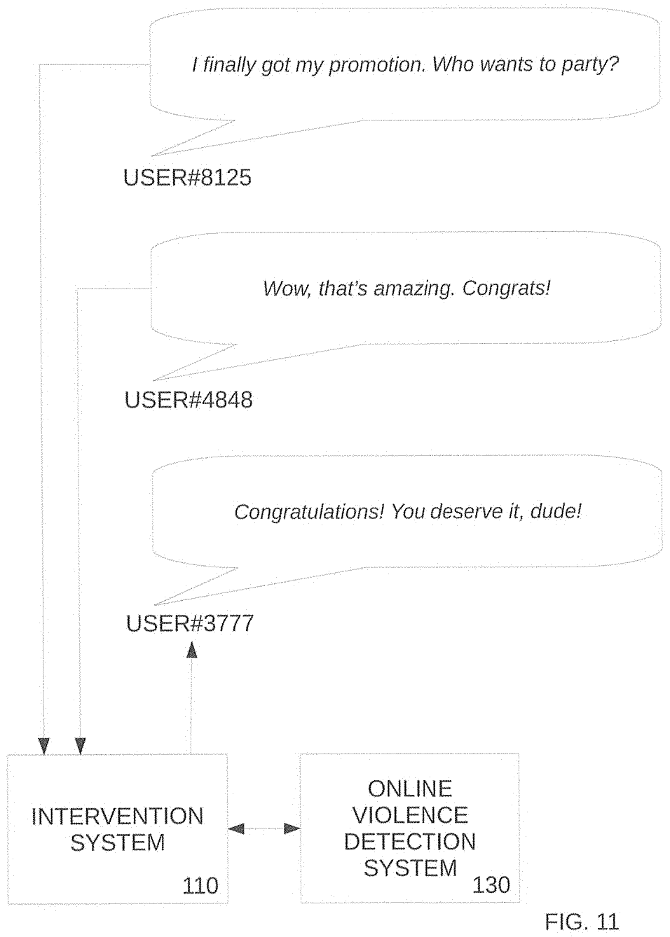

FIG. 11 is a diagram illustrating the process of sending non-intervention message according to an embodiment. The diagram shows another exemplary exchange of messages between three users that can be identified with their IDs: USER#8125, USER#4848, USER#3777. The first message written by USER#8125 is sent to Intervention System 110 and then to Online Violence Detection System 130, where it is classified as not containing online violence. No reaction. The second message from USER#4848 is also classified as not containing online violence. However, it is recognized by the internal classifier as a congratulation. Taking advantage of this opportunity, Intervention System 110 selects USER#3777 (one of the controlled chatter bots) and use it to send a non-interventional message that follows the reaction of previous user.

Intervention System

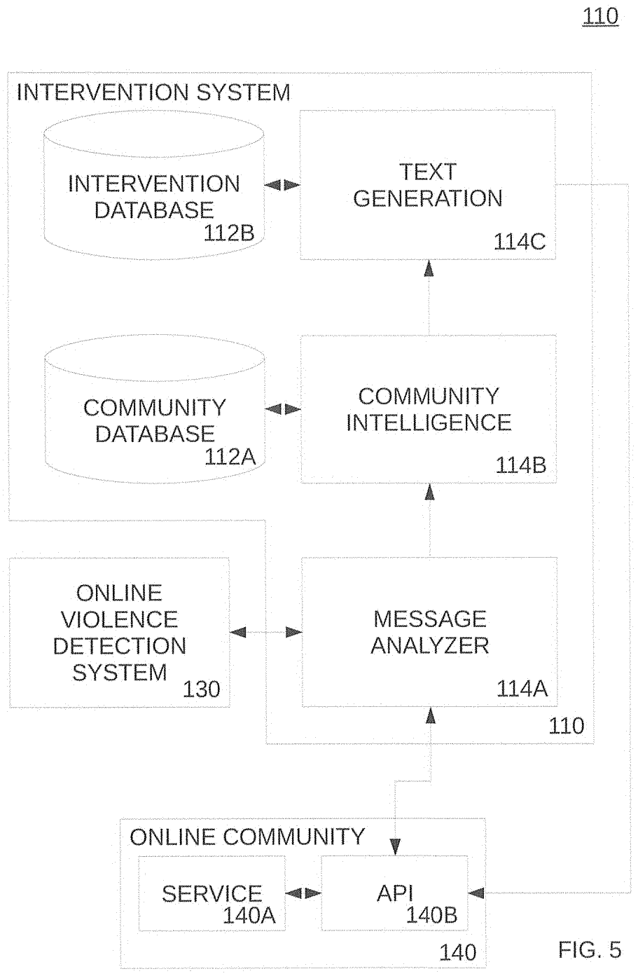

FIG. 5 is a block diagram of general architecture of intervention system modules according to an embodiment. Intervention System 110 comprises three main modules related to the consecutive stages of the intervention process:

Message Analyzer

Message Analyzer 114A is a module responsible for sending requests for and receiving messages and conversations from Online Community 140. The most recommended and convenient method of communication with Online Community 140 is to use its API 140B that allows developers to interact with Service 140A, e.g. reading and sending messages, creating and authorizing accounts, performing and automating moderators' actions. Most of the biggest online communities use APIs that their partners can be provided with. Many online communities offer access to their public APIs. In an embodiment, Message Analyzer 114A communicates with Online Community 140 using its API 140B. In other embodiment, Intervention System 110 is installed on the client's servers and integrated on-premise directly with client's Service 140A.

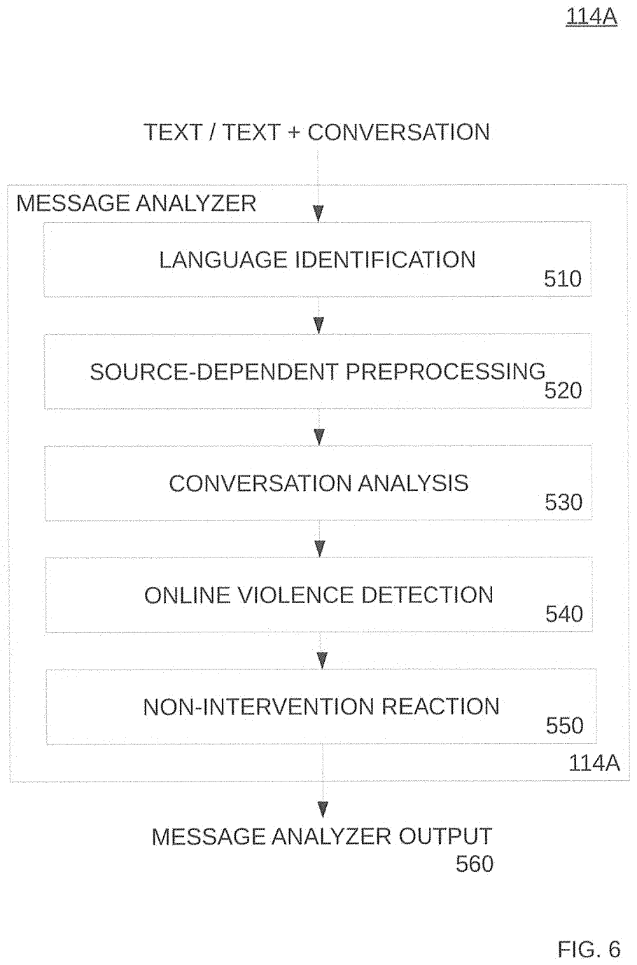

FIG. 6 is a block diagram of message analyzer module according to an embodiment. Message Analyzer 114A takes in text or text with responding conversation. The latter provides an opportunity to analyze broader context of input text. Both texts and conversations can be delivered in any readable form that can be translated to plain text, including (but not limited to): plain text, JSON format, CSV/TSV file, XML/HTML file, audio/video with selected speech recognition tools. Aside from texts and conversations, minimal amount of information required by Intervention System 110 can be defined with the following abilities:
ability to identify the user who sent the message (user id, username, login, email);
ability to identify the chronology of sending the messages.

Any other information about messages and users can be stored and used in the intervention process, including user's gender, age, ethnicity, location, and statistics regarding user's activity.

The process of Message Analyzer 114A starts with Language Identification 510. This submodule is responsible for determining which natural language given text is in. Most of the following modules and submodules are language-dependent and therefore Language Identification 510 comprises a router for assigning an incoming massage to a proper language flow.

Source-dependent Preprocessing 520 represents a set of text manipulation operations that remove, change, normalize or correct every source-dependent characteristics that may impede the proper work of Online Violence Detection System 130. In most cases, this relates to specific slang, expressions and behaviors that are distinctive for specific communities. For example, in some communities calling someone a “goat” can be offensive, whereas in others it can be very positive being an abbreviation for “greatest of all time.” Some communities (e.g. game streaming communities) tend to use a number of emotes (expressive images) that can be hard to understand by anyone outside the community. These emotes are often replaced with their textual equivalents when the message is sent using an API. It may lead to many errors if such text is processed with Online Violence Detection System 130 without any adjustments.

Conversation Analysis 530 comprises a submodule that analyzes a broader context of a single utterance. In general, a conversation can be defined as a set of previous messages (flat structure, chat) or a tree or subtree of previous messages within the same thread (hierarchical structure, forum). In both cases, a number of messages that can be assigned to a conversation should be bounded from above. If there are some messages that follow the analyzed text, they can be also included into the analysis with proper information. However, this is very rare for chatter bots since they usually react (nearly) real-time. As mentioned before, Message Analyzer 114A can take in text with conversation as an input.

Alternatively, Message Analyzer 114A can take in consecutive texts, collect them and treat as a conversations. This is not a default setting, though. Aside from a number of messages that can be assigned to a conversation, it requires to define conditions on incoming texts that allow to treat them as a single conversation.

The main objective of Conversation Analysis 530 is to identify and distinguish participants of the conversations from other persons that the conversation relates to. In other words, Conversation Analysis 530 allows to determine which relations are related to which persons and therefore to understand who is the real offender and who is the victim. Furthermore, online violence targeted against an interlocutor often requires different reaction than violence targeted against a non-interlocutor. For example, if there is a post about a homicide and users in comments refer to the murderer with “you should burn in hell”, it could be understandable to turn a blind eye on that, whereas the same utterance targeted against an interlocutor should be intervened. Additional objectives of Conversation Analysis 530 cover finding indicators that can either confirm or contradict what Online Violence Detection System 130 detects. For example, if there is a strong disagreement detected prior to the message potentially containing online violence, it increases the chance that online violence really occurred in that message.

Online Violence Detection 540 is a submodule responsible for communication with Online Violence Detection System 130. High precision is one of the features of Online Violence Detection System 130 in order to be used for autonomous interventions. Precision is here defined as: number of True Positives/(number of True Positives+number of False Positives), where: True Positives are inputs correctly classified as online violence and False Positives are inputs incorrectly classified as online violence. Low precision leads to undesirable and excessive interventions that in turn lead to dissatisfaction, and potentially leaving the service temporarily or even permanently. Furthermore, unwanted interventions can expose concealed chatter bots. It is crucial to minimize the rate of false accusations (and unwanted interventions) which is strictly related to precision of Online Violence Detection System 130.

Another feature of Online Violence Detection System 130 is in-depth categorization of online violence phenomena. Different types of online violence requires different types of reactions. For example, the best reaction to mild personal attack is often an empathetic intervention, whereas sexual harassment usually require a strong disapproval. In general, the more granular categorization, the better possibilities to assign proper reaction to detected messages. Ability to extract certain words and phrases related to online violence is another valuable feature as it can be used to generate a better intervention that precisely points out its rationale. For example, if a personal attack is detected because one user called another user an idiot, the intervention can point out that calling other users idiots is not accepted within this community. Whenever Online Violence Detection 540 detects any form of online violence, it sends a request for intervention to the following modules of Intervention System 110 along with complete information required for this process.

Non-intervention Reaction 550 is an additional submodule responsible for performing non-interventional activities described in the previous section. Non-intervention Reaction 550 works only if Online Violence Detection 540 does not detect any violence in the input text. In that case, Non-intervention Reaction 550 uses both internal and external classifiers and knowledge bases in order to determine when and how react. In an embodiment, Non-intervention Reaction 550 is capable of sending non-interventional messages directly to API 140B. In other embodiments it sends a request for non-interventional message to the following modules of Intervention System 110, exactly as in case of Online Violence Detection 540.

Message Analyzer Output 560 comprises a request for action to the following modules that contains a complete set of information regarding incoming texts and conversations, including (but not limited to):
request for intervention (boolean variable),
detected language,
types of detected violence,
words and phrases related to detected violence (if available),
user identification,
user-related data (if available);
timestamp.

The aforementioned set of information relates to the situation where Non-intervention Reaction 550 sends non-interventional messages directly to API 140B. Otherwise, Message Analyzer Output 560 has to contain a proper request and additional information required to prepare a non-interventional message within other modules. Message Analyzer Output 560 utilizes any data interchange format to transmit data objects through the following modules of Intervention System 110. In an embodiment, Message Analyzer Output 560 utilizes JSON format.

Community Intelligence

Community Intelligence 114B is a module responsible for analyzing user-related data in order to prepare the most effective intervention. Community Intelligence 114B has access to Community Database 112A, where all user-related data in regard to the given community is stored. The main piece of information stored in Community Database 112A is the whole track record of violent users, including (but not limited to):
user identification,
timestamp of violence detection,
timestamp of sending intervention,
type of detected violence (+related words and phrases),
type of received intervention,
id of received intervention that allows to retrieve an exact text of intervention message.

If Online Community 140 utilizes any form of social index such as number of followers, in-game status, community points (karma, likes, stars), it can be passed through from Message Analyzer 114A along with user identification and utilized by Community Intelligence 114B on the fly. However, it might be useful to see how social index changes over time. In this case, it can be stored in Community Database 112A as well and utilized by Community Intelligence 114B on demand.

There is also another important feature that can be used to evaluate performed interventions and in turn to provide better interventions in the future. If Online Community 140 utilizes community points or any other form of awarding good contributions, Message Analyzer 114A can proactively request Online Community 140 for such information regarding the intervention message. It can be performed for a predefined period of time in regular intervals. This information can be passed through the following modules of Intervention System 110 and stored in proper databases in order to increase chances of providing good interventions in the future. For example, if Online Community 140 allows its users to rate any message with positive or negative points (upvote and downvote), it can be used to evaluate how an intervention was accepted by other users. Positive points can indicate that the intervention was appropriate, where negative points can signa bad intervention or even a false positive in terms of online violence detection.

Community points can be very useful to evaluate interventions, but also they can be very misleading as bad intervention can be funny and get positive points for that reason. Due to that fact, Intervention System 110 offers another feature for intervention evaluation. Message Analyzer 114A can take in texts and conversations that follow any intervention and utilize a built-in or external classifier to evaluate if the message is positive or negative in regard to the intervention. There is a number of methods that can be used to do so, starting with sentiment analysis (statistical models) and ending with rule-based classifiers capable of detecting acknowledgement, gratitude, disapproval, and other possible reactions. In an embodiment, a hybrid method is utilized. In order to classify a message as positive, it has to be classified as positive by sentiment analysis and a positive reaction has to be detected by a rule-based classifier. For chats, it is important to determine if a message refers to the intervention. This is done in two ways. The primary method is to find a reference to the user that performed an intervention (e.g. using an interventor's username) or to the message itself (e.g. using a citation or staring a comment with specific terms like: “up:” or “to the above:”). The additional method consists in setting a very short timeframe for collecting messages after the intervention. Forums usually utilize a tree structure that makes this issue trivial.

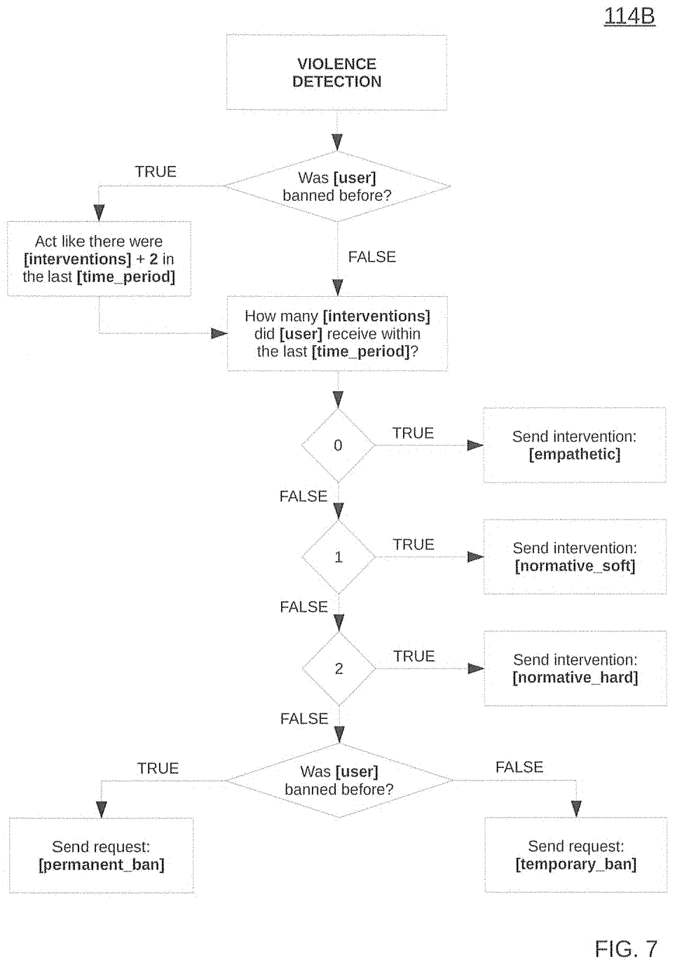

FIG. 7 is a block diagram illustrating the instance of community intelligence module according to an embodiment. The diagram demonstrates an exemplary configuration of Community Intelligence 114B. In an embodiment, the system is equipped with a set of predefined default configurations and a dedicated tool and methodology to edit existing and build new ones. The new configurations can be built using either a dedicated scripting language or any general purpose programming language. The configuration has access to and can utilize any information delivered in Message Analyzer Output 560 and stored in Community Database 112A. The configuration presented in FIG. 7 utilizes only information about previous interventions of the user and whether or not the user was previously banned. The required calculations and operations can be performed using the configuration script. For example, if Community Database 112A contains only entries describing previous interventions, the number of all interventions can be calculated in the script as a number of those entries.

The configuration described in FIG. 7 starts with a violence detection. The script verifies how many interventions the user got within a predefined time period prior to the current intervention. In an embodiment, the time period can be defined for the whole community as well as for its particular communication channels individually. Defining the time period is particularly important for fast-paced conversations in order to not exaggerate punishing for overdue offenses. For example, if the time period is defined as one hour and the user got interventions at 10:05 am, 10:23 am, 10:48 am and the current intervention was sent at 11:14 am, the first intervention at 10:05 am is overdue and therefore the user got only two interventions prior to the current intervention within the time period.

The penalties such as banning are defined by the online community (service). Intervention System 110 can easily adapt to any service and utilize any reasonable combinations of available penalties, including the following aspects:
type of penalty: banning, shadow banning, setting restraints on writing/editing;
duration: temporary (e.g. 24 hours), permanent;
range: selected channel (e.g. thread on forum), whole service.

The configuration described in FIG. 7 allows two types of penalties: temporary ban and permanent ban. The script verifies if the user was banned before and—if the test is positive—it adds 2 to the number of interventions obtained by the user within the predefined time period. Then, based on that number, the configuration sends a request to the last module of Intervention System 110. If the final number of interventions is:
0, a request for empathetic intervention is sent;
1, a request for normative soft intervention is sent;
2, a request for normative hard intervention is sent;
more than 2 and the user was not previously banned, a request for temporary ban is sent;
more than 2 and the user was previously banned, a request for permanent ban is sent.

Every configuration of Community Intelligence 114B comprises a set of logical instructions and conditional statements coded using a general purpose programming language or even a dedicated scripting language. Therefore, it can be easily created and modified, even by a person with minimal programming skills. Every data object from Message Analyzer Output 560 and entry from Community Database 112A can comprise a variable in the configuration script. The output of Community Intelligence 114B consists of Message Analyzer Output 560 filled with a detailed request for action (Message Analyzer Output 560 provides only a boolean request variable). In an embodiment, for the purpose of clarity, writing to Community Database 112A is excluded from the configurations and is performed by special writing scripts. The entire output of Community Intelligence 114B is written to Community Database 112A after running the configuration script by default. The writing can be extended with any other information derived from running the configuration script or writing script. In other embodiment, writing to Community Database 112A can be performed using the configuration script.

An important objective of Community Intelligence 114B is to collect new knowledge about users of the online community. In order to do so, Community Intelligence 114B has to analyze the user-related information delivered by Message Analyzer Output 560. The richer information delivered, the more fruitful this analysis can be. Therefore, it is important to set a good cooperation of these two modules. One of the most important methods for collecting knowledge about users is to predefine some user's characteristics and assign them to the users based on how they communicate and react on interventions. The characteristics can comprise a descriptive label with some confidence score attached. The score can be either binary (true/false) or non-binary (a score from 0 to 1). For example, if a user tends to use coarse language in his or her communication, the user can be labeled as “vulgar” with the score defined as a fraction of messages containing vulgarisms to all messages. If a user reacts well to some type of interventions (e.g. authoritative), he or she can be labeled as sensitive to this specific type (e.g. authoritative-sensitive). In an embodiment, a set of user's characteristics is predefined and both Message Analyzer 114A and Community Intelligence 114B are properly configured to collect them. Other characteristics can be easily defined and configured within the system.

The configuration described in FIG. 7 can be easily modified in order to take into account the characteristics described in the previous paragraph. For example, if there are many users who appeared to be more sensitive to authoritative than empathetic interventions, one can add another conditional statement before sending a request for empathetic intervention. This statement can verify if the user is labeled as authoritative-sensitive and—if so—send a request for authoritative instead of empathetic intervention.

A life cycle of using Intervention System 110 within Online Community 140 largely depends on the amount of collected data. Therefore, it is usually the most effective to start off with rule-based and algorithmic approaches. Then, as the amount of collected data grows, it is reasonable to follow up with a hybrid approach introducing more and more statistical approaches. A mature integration should utilize a hybrid approach reinforced with very advanced statistical approaches that can truly benefit from large datasets. An example of introducing a hybrid approach to the diagram described in FIG. 7 is to keep the symbolic methods for determining when to send the interventions and to apply statistical classifiers for choosing what intervention should be sent based on all user-related data available in Community Database 112A.

There is another important feature of Community Intelligence 114B that largely benefits from statistical and machine learning approaches. This feature is a user clusterization. Community Intelligence 114B allows to collect a large amount of user-related data, starting with user meta data such as gender or age, through social index data such as number of followers, ending with user's characteristics derived from various analyses. The objective of user clusterization is to form virtual groups of users based on the similarities between these users in order to apply the collected knowledge about the users not only to the individuals but also to the whole groups. In an embodiments, the user clusterization is performed using various clustering algorithms. Therefore, one user can be assigned to many different clusters. The clustering can be performed on demand or scheduled according to one or more selected events, e.g. once a day at a specified time or after performing a specified number of interventions. The clusters can be displayed and modified manually at any given moment. Information about being in a specific cluster is available for every user and can be utilized in the exact same manner as any other user-related data.

Text Generation

Text Generation 114C is the last module of Intervention System 110 that communicates back with Online Community 140, preferably through its API 140B. The main objective of Text Generation 114C is to compose a message according to the request and other information derived from Community Intelligence 114B and Message Analyzer 114A. The composed message is transferred to Online Community 140, where it is sent (written, posted) utilizing a chatter bot controlled by Intervention System 110. There are three major types of the composed messages:
intervention messages;
non-intervention messages if such messages were not prepared within Message Analyzer 114A module (Non-intervention Reaction 550);
supporting messages sent (usually as a direct or private message) to the users upon whom any of the typical moderator's action was taken in order to explain the rationale for taking the action.

Aside from composing messages, Text Generation 114C is responsible for transmitting requests for moderator's actions from previous modules to the chatter bots with proper authorizations.

As mentioned in the previous sections, interventions come in many variations that can be derived from any applicable criteria, including (but not limited to): social science research categories, desired effects, role-playing purposes, and so on. Furthermore, interventions vary in length according to the community they are going to be used on. Chats utilize short messages, whereas forums usually embrace longer forms. Revealed chatter bots can repeat themselves, whereas concealed chatter bots should avoid this in order to not being exposed. Each online community may require different interventions. Therefore, Text Generation 114C utilizes a text generation instruction (txtgen instruction) in a form of special script that describes in details how the interventions are composed. Similarly to the configurations from Community Intelligence 114B, txtgen instructions are built using either a dedicated scripting language or any general purpose programming language. Every txtgen instruction of Text Generation 114C comprises a set of logical instructions and conditional statements and therefore can be easily created and modified, even by a person with minimal programming skills. In order to work properly, a txtgen instruction has to describe every type of intervention that can be requested for a given community.

In an embodiment, interventions are composed from building blocks: words, phrases, clauses, sentences and utterances. These building blocks are stored in Intervention Database 112B and organized as functional groups. A functional group comprises a group of words, phrases, clauses, sentences and utterances with a specific purpose within an intervention. An example of a simple functional group is a “greeting” functional group that can be used to start the intervention. The “greeting” functional group contains the following words and phrases: “hi”, “hey”, “hello”, “hello there”, “good day”, and so on.

Complex functional groups are further divided into smaller sub-groups of building blocks, where an utterance representing the functional group is formed by taking one arbitrary building block from each consecutive sub-group. An example of a complex functional group is a “giving perspective” functional group that can be used to show the universality of the experience of being not understood while creating an introduction for the further part of intervention. The “giving perspective” functional group contains four following sub-groups:
A={“some behaviors”, “certain things”, “some things”, “certain behaviors”, “what other people are saying or doing”, “everybody does something that”, “who doesn't behave in a way that”};
B={“can be”, “may be”, “might be”};
C={“hard for us to understand”, “hard to get for some people”, “difficult to grasp”, “difficult to understand”, “not easy to grasp”, “tough to comprehend”, “harder to understand”};
D={“but let's keep in mind”, “still try to remember”, “let's try to remember”, “please remember”}.

The groups and sub-groups can be modified and developed as long as the building blocks fit well with each others. Each intervention is composed from representatives of specific functional groups. Therefore, txtgen instruction describes which functional groups should be used and how in order to compose a selected type of intervention. For example, an empathetic intervention can be defined as: “greeting” +“giving perspective” +“common humanity”, where the latter comprises one of the following utterances: “there is a human with feelings on the other side”, “you never know what someone might be going through”, “you never really know what is life like for the other person”, and so on. By default, the building blocks are selected randomly utilizing additional algorithms for avoiding repetitions. As the system develops and the collected data grows, the building blocks are selected using more sophisticated statistical and machine learning methods that take into consideration the effectiveness of specific combinations applied on specific groups of users under specific conditions.

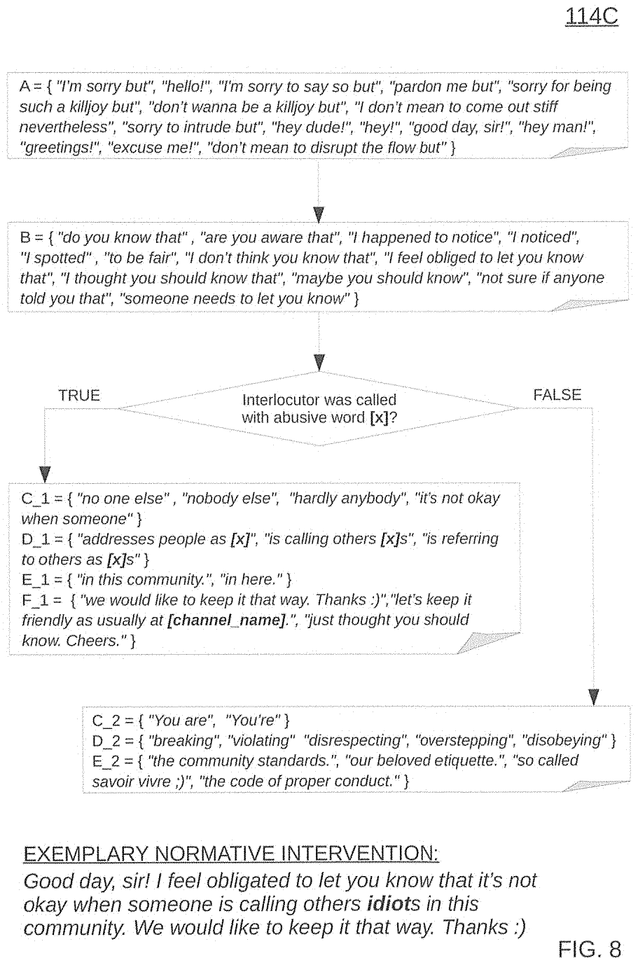

FIG. 8 is a block diagram illustrating the instance of text generation module according to an embodiment. The diagram represents a part of txtgen instruction describing how to compose a normative intervention. The first two blocks, A and B, represent two simple functional groups, similar to those presented in the previous paragraphs. Functional group A comprises “greeting” building blocks, whereas functional group B comprises “informing” blocks that can be used to inform the user about some facts or opinions. After selecting building blocks from A and B, txtgen instruction utilizes a conditional statement to verify if Message Analyzer Output 560 passed through Text Generation 114C contains a data object with words and phrases related to detected online violence. If so, it continues with a complex functional group (C_1 to F_1) in order to form the last building block that refers to the norm and utilizes information about the words and phrases related to detected online violence. Otherwise, it utilizes another complex functional group (C_2 to E_2) that also refers to the norm but does not require any additional information. At the bottom of FIG. 8, there is an exemplary normative intervention generated by selecting one building block from groups: A, B, C_1, D_1, E_1 and F_1 according to the aforementioned txtgen instruction.

In order to increase the diversity of the interventions, additional submodule is introduced at the end of Text Generation 114C. This submodule is called a mixer and its main objective is to perform a set of randomized string manipulations on the intervention composed beforehand with txtgen instructions. The mixer utilizes both symbolic and statistical approaches in order to perform various sting manipulations, including (but not limited to):
paraphrase generation on any structural level of the intervention, from the whole intervention, through sentences and clauses, to individual phrases (mainly machine learning approaches);
synonym replacement for words and phrases using available lexical databases and preserving proper grammatical forms (mainly rule-based approaches);
typo insertion utilizing dictionary-based replacements (common typos and misspellings, e.g. “tommorow” instead of “tomorrow”) and rule-based replacements that range from well-known phenomena (e.g. using single letter instead of double, “ae” instead of “ea”, “ht” instead of “th”) to methods taking into account the proximity of letters on a keyboard layout;
punctuation changes (switching punctuation marks—periods, commas, dashes, and so on);
letter case changes (switching from lower- to upper-case and otherwise).

Each type of string manipulations can be either applied or not. The process of selection is randomized and one can define what should be the probability of applying specific string manipulation. Similarly with the number defining how many times each manipulation is applied. This can be also defined individually for each manipulation and randomized.

Other embodiments may comprise different methods for composing interventions. For example, it is possible to utilize advanced machine learning techniques for text and paraphrase generation (e.g. deep reinforcement learning) in order to generate very diverse interventions from seed samples, where each seed sample comprises a finite set of complete interventions defined separately for each type of interventions. In this case, interventions are not composed from building blocks, but rather automatically generated by machine learning models based on patterns derived from the seed samples. Each new successful intervention can be included into corresponding seed sample in order to further increase the pattern diversity.

Intervention System with Human Mediators and Human Moderators

As mentioned in the previous sections, Intervention System 110 is able to work autonomously using only chatter bots, without any human assistance. However, it can be very effective to introduce a human-machine collaboration. There are two major methods for establishing such collaboration. The first method introduces human mediators who can take over a part (or even the whole) of the work performed by the chatter bots. The second method introduces human moderators who can supervise the work performed by the chatter bots. In both cases, the new workflow requires a moderation dashboard as a central hub for coordinating the work of human mediators, supervising chatter bots and performing moderation-related actions. However, introducing any kind of human-machine collaboration does not require to utterly resign from using Intervention System 110 autonomously, exactly as it was described in the previous section and presented in FIG. 5.

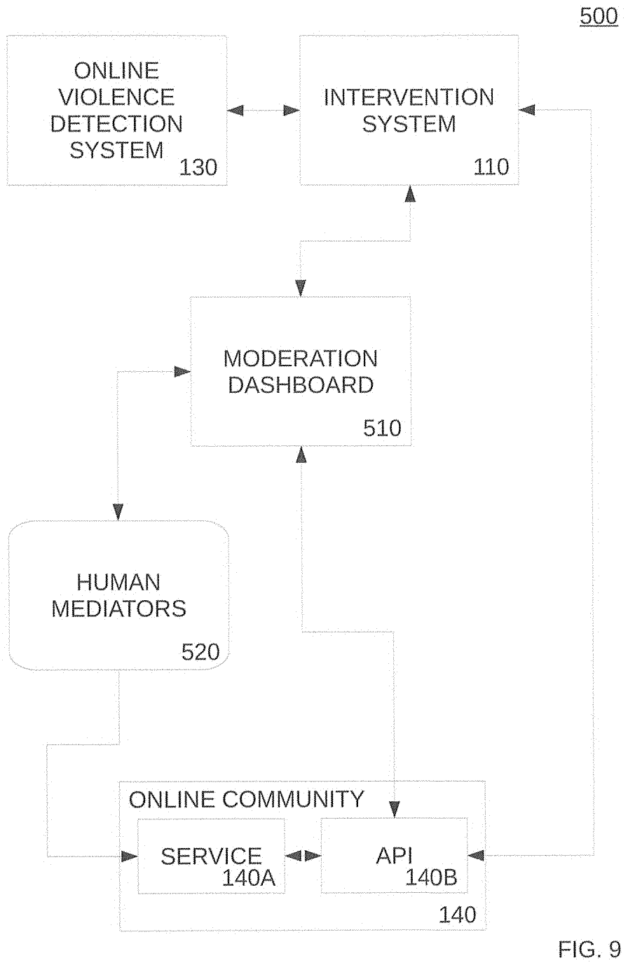

FIG. 9 is a block diagram of intervention system utilizing a moderation dashboard according to an embodiment. The autonomous method of utilizing Intervention System 110 is represented with the line on the right that connects Intervention System 110 directly with API 140B of Online Community 140. Moderation Dashboard 510 comprises a set of tools for moderators designed to ease and simplify their work. Human Mediators 520 can use selected functionalities of Moderation Dashboard 510 to perform interventions or they can work independently. In the latter case, Moderation Dashboard 510 coordinates the work of Human Mediators 520. Moderation Dashboard 510 can be either an integral part of Online Community 140 or a standalone system that communicates with Online Community 140 using its API 140B. Human Mediators 520, in case of not using Moderation Dashboard 510, perform interventions using Service 140A of Online Community 140.

Human Mediators

The work of Human Mediators 520 within Moderation Dashboard 510 can be organized in two ways. The first one is proactive. Human Mediators 520 gain access to a dedicated panel where they can log in and see the full list of pending interventions. Each pending intervention can be described in details with all information derived from Message Analyzer 114A and Community Intelligence 114B. It allows the mediator to make an informed decision about taking or leaving the particular intervention. Additionally, the mediator becomes acquainted with a proposed intervention derived from Text Generation 114C and can decide to use it, modify it or create a new one from scratch. Once the intervention is taken, it is removed from the list of pending interventions. It is possible to set up a time limit for pending interventions. In this case, if any intervention remains too long on the list, it is automatically performed by a chatter bot.

The second approach is passive. Moderation Dashboard 510 assigns intervention to each of Human Mediators 520 based on their strengths and weaknesses derived from collected statistics. Each mediator has access to an individual panel with the list of assigned interventions. As in case of the proactive approach, each intervention is described in details with all information derived from Message Analyzer 114A and Community Intelligence 114B, and provides a proposed intervention message derived from Text Generation 114C. In this case, however, the objective of the mediator is to perform all interventions from the list. If any mediator becomes overloaded, Moderation Dashboard 510 redirects incoming interventions to underloaded mediators or chatter bots.

Both approaches can be modified and refined with new features in order to optimize the workflows. Both approaches utilize the communication methods established between Moderation Dashboard 510 and API 140B of Online Community 140. Therefore, Human Mediators 520 do not need to be logged on their user accounts in Service 140A. The accounts can be authorized within Moderation Dashboard 510 and controlled by Human Mediators 520 indirectly. In both approaches, the system providing the panels for Human Mediators 520 can be either installed on the same device as Moderation Dashboard 510 or located anywhere that is accessible to a connected network (typically the Internet) and distributed geographically in the known manner. Nevertheless, in either case, the panels can be treated as a part of Moderation Dashboard 510.

Human Mediators 520 can also work without any panel with the list of interventions. In this case, Moderation Dashboard 510 communicates with each of Human Mediators 520 individually, using any predefined method of communication, including (but not limited to): private or direct message within Online Community 140, instant messaging application or platform, email or text message (SMS). Each new pending intervention is assigned to an available mediator by Moderation Dashboard 510 in the similar way as in case of the passive approach. Then, Moderation Dashboard 510 sends a request for intervention using a selected method of communication. The request contains all information derived from Message Analyzer 114A, Community Intelligence 114B and Text Generation 114C, exactly as in case of the panels in Moderation Dashboard 510.

Aside from that, the mediator is provided with a direct link to the message that requires an intervention if such feature is available within Online Community 140. Human Mediators 520 perform the intervention using their user accounts within Service 140A. If a request length is limited by the selected form of communication (e.g. SMS), a dedicated temporary static HTML page containing the complete information is generated. A mediator is provided with the url to this page that can be opened using any web browser.

Human Moderators

Moderation Dashboard 510 is an operational center for human moderators. Most of online communities utilize some sort of moderation dashboards, where moderators become acquainted with the messages that require their attention and perform moderator's actions such as removing messages, blocking threads, banning and shadow banning users, setting restraints on writing and editing, and so on. The objective of integrating Moderation Dashboard 510 with Intervention System 110 is to ease and automate the work of human moderators and to introduce the concept of interventions reducing online violence to Online Community 140.

As Intervention System 110 is able to work autonomously, the boundaries for collaboration between the system and human moderators can be defined with two extremes. The first one is a supervision “after” where every autonomous action of Intervention System 110 is allowed and human moderators only verify the correctness of such actions afterwards. The second one is a supervision “before” where none of the actions (including interventions) of Intervention System 110 is performed autonomously and each of them requires a permission from human moderators in order to be performed.

The supervision “after” utilizes a dedicated panel where all actions performed by Intervention System 110 are logged and divided into pragmatic categories: interventions along with their types, removals of messages, bans of users, and so on. The panel allows to browse through the actions by their types and other features as well as search for specific actions based on various searching criteria. For this type of supervision, it is especially important to involve the users of Online Community 140 into the feedback loop by allowing them to report any autonomous actions, as presented in FIG. 3 and described in the previous sections of this document. Such feedback loop can be used to prioritize the actions and determine their positions within the panel. In large communities, it might be reasonable to verify only the actions reported at least by one user and treat all the others as correct. The supervision “before” resembles in a way the panels for Human Mediators 520. A human moderator can see the full list of proposed actions and decide which ones should be accepted or rejected. In any other aspects, the list is organized exactly as in case of the supervision “after”, including the categorization as well as the browsing and searching capabilities.

Any form of supervision between “before” and “after” is accepted. The most natural and balanced form of supervision is to let the interventions be completely autonomous (with user reporting) and to demand the moderator's acceptance for all other actions. The form of supervision can vary as Intervention System 110 becomes more adjusted to Online Community 140. Therefore, it is possible to let the system become more and more autonomous. For example, a reasonable next step (after allowing autonomous interventions) is to let the system perform message removals and short-term banning, whereas long-term and permanent banning remains under the exclusive moderator's control.

Another important feature of Moderation Dashboard 510 is a management tool for chatter bots. The tool allows to monitor the chatter bots in terms of:
their types and personalities (for role-playing chatter bots);
types of interventions as different chatter bots can utilize different types of interventions;
effectiveness measured as a reduction of online violence over the time;
precision of online violence detection.

The management tool allows to see the full track record of each chatter bot. Furthermore, it allows to create new chatter bots using predefined templates as well as disable or delete the existing ones. It is also possible to provide Moderation Dashboard 510 with more advanced functionalities that allow human moderators to create new personalities and interventions for chatter bots.

Optimization and Development of Intervention System

Many of the module-specific optimization and development methods are described in details in the previous sections related to the corresponding modules of Intervention System 110. Therefore, the following section provides some addition remarks and general insights.

In order to optimize any system, one has to define a success rate that can be evaluated with measurable metrics. For Intervention System 110, it is reasonable to define the success rate as a reduction of online violence within Online Community 140. This can be measured over time with Online Violence Detection System 130. A level of violence can be defined as a number of messages containing online violence to the number of all messages and can be calculated for any time period. For example, in order to verify the effectiveness of interventions, one can measure the level of violence for one month, then apply the intervention for another month, and eventually measure the level of violence once again for yet another month. Comparing the level of violence from the first and the third month, one can evaluate if the level of violence increased or decreased.

Due to the fact that evaluating the success rate requires time, it is recommended to apply A/B testing in order to compare different settings of Intervention System 110. A/B testing is a randomized experiment with two variants, A and B. It can be further extended to test more variants at once and—for the sake of clarity—A/B testing will always refer to this kind of tests, no matter how many variants will be tested. In order to perform A/B testing, one has to assure that uncontrolled variables are negligible. In other words, one has to assure that all the tested variants are maximally similar to each other with the exception of the tested variable. Therefore, A/B testing should be applied on similar channels (e.g. chatrooms, sub-forums) or similar groups of users. The similarity of channels and groups can be measured using various parameters collected by Community Intelligence 114B and stored in Community Database 112A, including (but not limited to): number of active user, user's activeness, user's social indexes, user's characteristics, level of online violence, distribution of online violence categories. The similar groups can be selected either manually or automatically using various methods for determining similarities based on available parameters.

Once the similar groups are selected, the tested variable has to be introduced to the tested variant. The tested variable can comprise any change in the way how the system works. Several examples of the tested variables: adding new type on interventions, adding new personality for role-playing chatter bots, changing text generation instruction, changing text generation method or algorithm, changing configuration of Community Intelligence 114B. As a rule of thumb: the smaller change, the better due to the lower probability of the occurrence of uncontrolled variables. In an embodiment, the tested variable is selected manually by trained engineers or data scientists. In other embodiments, the tested variable can be selected automatically by the system. Alternatively, the system can provide recommendations that can be accepted or rejected by a human operator.

The A/B testing is evaluated after a period of time by comparing the level of online violence between all tested variants. The time period can be predefined or the experiment can last until any differences between tested variants become noticeable. If the tested variable appears to be successful, it can be applied to the system either manually, automatically or semi-automatically after a human operator's acceptance.

What is claimed is:

1. A intervention system for intervening in online bullying, the system comprising:
multiple databases available online;
multiple system processors available online;
an online violence detection system available online on communicatively coupled to the multiple databases and the multiple system processors, wherein the online detection system is also communicatively coupled to multiple online communities, multiple data sources, and multiple other online systems and online applications;
the intervention system executing, through the multiple processors, the method for intervening in online bullying, comprising
receiving published material;
interacting with the online violence detection system;
determining whether autonomous instant action is appropriate, or whether referring the interaction to a moderation dashboard is appropriate;
generating user reporting and also generating a moderator's verification, wherein the moderation dashboard also can generate a moderator action.

2. The system of claim 1, wherein the method executed by the intervention system further comprises interventions performed by automatic agents comprising chatter bots, and wherein the interventions do not include blocking users, deleting users, or banning users.

3. The system of claim 1, wherein the method executed by the intervention system further comprises interventions performed by human mediators, and wherein the interventions do not include blocking users, deleting users, or banning users.

4. The system of claim 1, wherein the method executed by the intervention system further comprises interventions performed by human mediators and chatter bots, and wherein multiple interventors may be chosen among the following:
concealed chatter bot;
revealed chatter bot;
amateur human mediator; and
professional human mediator.

5. The system of claim 4, wherein the intervention system dynamically manages chatter bots, including adding new chatter bots to the system, assigning chatter bots to certain identified groups of violent users, and generating new chatter bots as needed.

6. The system of claim 1, wherein the method further comprises:
defining types of interventions, including empathetic, normative, and authoritative.

7. The system of claim 1, wherein the method further comprises defining types of interventions by an effect desired to be had on a violent user.

8. A intervention system for intervening in online bullying, the system comprising:
multiple databases available online, comprising a knowledge base that that includes popular conversation topics, a set of predefined scripts, and classifiers predefined to interoperate with the knowledge base;
multiple system processors available online;
an online violence detection system available online on communicatively coupled to the multiple databases and the multiple system processors, wherein the online detection system is also communicatively coupled to multiple online communities, multiple data sources, and multiple other online systems and online applications;
the intervention system executing, through the multiple processors, the method for intervening in online bullying, comprising
receiving published material;
interacting with the online violence detection system;
determining whether autonomous instant action is appropriate, or whether referring the interaction to a moderation dashboard is appropriate;
generating user reporting and also generating a moderator's verification, wherein the moderation dashboard also can generate a moderator action.

9. The system of claim 8, wherein the method executed by the intervention system further comprises interventions performed by automatic agents comprising chatter bots, and wherein the interventions do not include blocking users, deleting users, or banning users.

10. The system of claim 8, wherein the method executed by the intervention system further comprises interventions performed by human mediators, and wherein the interventions do not include blocking users, deleting users, or banning users.

11. The system of claim 8, wherein the method executed by the intervention system further comprises interventions performed by human mediators and chatter bots, and wherein multiple interventors may be chosen among the following:
concealed chatter bot;
revealed chatter bot;
amateur human mediator; and
professional human mediator.

12. The system of claim 11, wherein the intervention system dynamically manages chatter bots, including adding new chatter bots to the system, assigning chatter bots to certain identified groups of violent users, and generating new chatter bots as needed.

13. The system of claim 8, wherein the method further comprises:
defining types of interventions, including empathetic, normative, and authoritative.

14. The system of claim 8, wherein the method further comprises defining types of interventions by an effect desired to had on a violent user.

15. A intervention and detection method for detecting and intervening in online bullying, the method comprising:
accessing multiple databases available online;
accessing multiple system processors available online;
receiving published material;
determining whether autonomous instant action is appropriate, or whether referring the interaction to a moderation dashboard is appropriate;
generating user reporting and also generating a moderator's verification, wherein the moderation dashboard also can generate a moderator action.

16. The method of claim 15, wherein the method executed by the intervention system further comprises interventions performed by automatic agents comprising chatter bots, and wherein the interventions do not include blocking users, deleting users, or banning users.

17. The method of claim 15, wherein the method executed by the intervention system further comprises interventions performed by human mediators, and wherein the interventions do not include blocking users, deleting users, or banning users.

18. The method of claim 15, wherein the method executed by the intervention system further comprises interventions performed by human mediators and chatter bots, and wherein multiple interventors may be chosen among the following:
concealed chatter bot;
revealed chatter bot;
amateur human mediator; and
professional human mediator.

19. The method of claim 18, including adding new chatter bots to the system, assigning chatter bots to certain identified groups of violent users, and generating new chatter bots as needed.

20. The method of claim 15, further comprising defining types of interventions, including empathetic, normative, and authoritative.
